(19) United States
(12) Patent Application Publication
(10) Pub. No.: US 2022/0308150 A1
(43) Pub. Date: Sep. 29, 2022

(54) METHOD FOR DIRECTION-OF-ARRIVAL ESTIMATION BASED ON SPARSE RECONSTRUCTION IN THE PRESENCE OF GAIN-PHASE ERROR

(71) Applicant: ZHEJIANG UNIVERSITY, Hangzhou (CN)

(72) Inventors: Chunyi SONG, Hangzhou (CN); Dingke YU, Hangzhou (CN); Qin CHEN, Hangzhou (CN); Yuzhang XI, Hangzhou (CN); Xin WANG, Hangzhou (CN); Wenwei FANG, Hangzhou (CN); Zhiwei XU, Hangzhou (CN); Bing LAN, Hangzhou (CN); Huan LI, Hangzhou (CN)

(21) Appl. No.: 17/830,258

(22) Filed: Jun. 1, 2022

Related U.S. Application Data
(63) Continuation of application No. PCT/CN2021/109106, filed on Jul. 29, 2021.

(30) Foreign Application Priority Data
Mar. 8, 2021 (CN) 202110250839.0

(51) Int. Cl. G01S 3/14; G01S 3/74

(52) U.S. Cl. CPC G01S 3/143; G01S 3/74

(57) ABSTRACT

Disclosed is a method for direction-of-arrival estimation based on sparse reconstruction in the presence of gain-phase error, which comprises the following steps: firstly, estimating a noise power and an gain error from an array received signal by adopting a characteristic decomposition method; then, based on a compensated covariance matrix, transforming a direction-of-arrival estimation problem into a non-convex optimization problem in a sparse frame by a method of sparse reconstruction; finally, estimating a grid angle and a deviation angle by using an alternate optimization method. This estimation method can effectively eliminate the influence of a phase error in direction-of-arrival estimation, and has better adaptability, which improves the resolution and estimation accuracy of the algorithm.

### CROSS-REFERENCE TO RELATED APPLICATIONS

The present application is a continuation of International Application No. PCT/CN2021/109106, filed on Jul. 29, 2021, which claims priority to Chinese Application No. 202110250839.0, filed on Mar. 8, 2021, the contents of both of which are incorporated herein by reference in their entireties.

### TECHNICAL FIELD

The present disclosure relates to the field of array signal processing, in particular to a method for direction-of-arrival (DOA) estimation based on sparse reconstruction in the presence of gain-phase error.

### BACKGROUND

Direction-of-arrival estimation of signals is an important research content in the field of array signal processing, and it is widely used in radar, sonar, wireless communication and other fields. There are many classical high-resolution algorithms for signal DOA estimation, including Multiple Signal Classification (MUSIC) algorithm and Estimation of Signal Parameters via Rotational Invariance Techniques (ESPRIT) algorithm. Most of these classical high-resolution algorithms are based on the premise that the array manifold is accurately known. In practical engineering applications, the variation of climate, environment, array components and other factors results in the inconsistent gain of amplifiers when signals are transmitted in channels, which leads to gain-phase errors between the channels of array antennas, which will lead to the deviation of the actual array manifold, and make the performance of classical high-resolution signal DOA estimation algorithms drop sharply or even fail in severe cases.

The early array error calibration was mainly realized by directly measuring, interpolating and storing the array manifold. Then, by modeling the array disturbance, people gradually transformed the array error calibration into a parameter estimation problem, which could be roughly divided into active calibration and self-calibration. Active calibration requires external auxiliary sources or other auxiliary facilities, which increases the cost of signal DOA estimation equipment to a certain extent, and has strict requirements on hardware and environment, which is not applicable in many cases. Self-calibration is to estimate the signal DOA and array error parameters according to some optimization function. It doesn't need additional auxiliary sources with accurate orientations and can realize on-line estimation. With the rapid development of modern information technology, the signal environment is changing towards the conditions of low signal-to-noise ratio and limited number of snapshots. Under such conditions, the performance of the existing calibration algorithms based on subspace is not satisfactory, which brings great challenges to the gain-phase error self-calibration algorithms that need a large number of received data.

In recent years, the rise and development of the sparse reconstruction technology and compressed sensing theory have attracted a large number of scholars to do research. The methods for DOA estimation based on sparse reconstruction in the presence of gain-phase error calibration provide a new idea for the calibration algorithm in the modern signal environment, which has better adaptability to the arbitrary array shape and requires less data. The array data model is expressed in a sparse form, and then the original signal is obtained by solving the optimization problem, and then the DOA can be obtained, which can greatly improve the accuracy of the estimation algorithm, thus making up for the shortcomings of the traditional algorithms. In actual experiments, it is necessary for this kind of method to divide the whole spatial domain into grids, and the degree of network division will directly affect the computational complexity of the algorithm and the estimation accuracy of DOA. When the signal direction does not strictly fall on the divided grid (Off-grid), the deviation error will be introduced, which will lead to the decrease of the estimation accuracy with the increase of the deviation between the real signal and the grid.

### SUMMARY

In view of the shortcomings of the prior art, the present disclosure provides a method for direction-of-arrival estimation based on sparse reconstruction in the presence of gain-phase error, and the specific technical solution is as follows.

A method for direction-of-arrival estimation based on sparse reconstruction in the presence of gain-phase error includes the following steps:

S1, calculating a covariance matrix R from an array received signal X(t), estimating a noise power by adopting a characteristic decomposition method, and estimating and compensating an gain error according to the noise power and main diagonal data of the covariance matrix to obtain a compensated covariance matrix R₁;

S2, according to the compensated covariance matrix R₁ obtained in S1, transforming a direction-of-arrival estimation problem into a nonconvex optimization problem in a sparse frame by a method of sparse reconstruction;

S3, transforming a two-parameter non-convex optimization problem into a convex optimization problem by using an alternating optimization method, and obtaining a grid angle and a deviation angle by solving the convex optimization problem, and obtaining a final information source angle estimation value.

Furthermore, S1 is implemented by the following substeps:

S1.1: calculating the covariance matrix R of the array received signal X(t), and then implementing eigenvalue decomposition on the covariance matrix R by using the following formula to obtain an eigenvalue λₘ in a descending order

R=Σₘ₌₁^{M}λₘvₘvₘ^{H} (1)

where M represents a number of array elements, λₘ represents the eigenvalue arranged in a descending order, vₘ represents an eigenvector corresponding to the eigenvalue λₘ and (⋅)^{H} represents the conjugate transpose;

S1.2: estimating the noise power \hat{σ}ₙ² by using the following formula according to the eigenvalue λₘ obtained in S1.1,

$${\hat{σ}}_{n}^{2} = \frac{1}{M - K} {\sum }_{m = K + 1}^{M} {λ}_{m} \qquad ( 2 )$$

where K represents a number of information sources;

S1.3: estimating the gain error by using the following formula according to the obtained covariance matrix R and the estimated value \hat{σ}ₙ² of the noise power

$${ρ}_{m} = \sqrt{\frac{{r}_{m , m} - {\hat{σ}}_{n}^{2}}{{r}_{1 , 1} - {\hat{σ}}_{n}^{2}}} \qquad ( 3 )$$

where ρₘ represents the estimated value of the gain error of the m^{th} array element and r_{m,m} represents the value at the covariance matrix (m, m);

S1.4: compensating the estimated gain error matrix ρₘ in the covariance matrix R by using the following formula, and eliminating the influence of the gain error to obtain a compensated covariance matrix R₁

R₁=G⁻¹(R−\hat{σ}ₙ²I_{M})(G⁻¹)^{H} (4)

where G=diag{[ρ₁, ρ₂, . . . , ρₘ]} represents an gain error estimation matrix and I_{M} represents an identity matrix with a size of M.

Furthermore, S2 is specifically realized through the following sub steps:

S2.1: according to the compensated covariance matrix R₁, taking the magnitude of the elements in the matrix to obtain |R₁|, and taking the elements in an upper triangle area thereof, and eliminating the repeated elements of a same size in a main diagonal line, and then rearranging according to the following formula

x=[|r̅_{1,1}|,|r̅_{1,2}|, . . . ,|r̅_{1,M}|,|r̅_{2,3}|, . . . ,|r̅_{2,M}|, . . . ,|r̅_{M-1,M}|]^{T}=|B̅p̅| (5)

B̅=[b(θ₁),b(θ₂), . . . ,b(θ_{K})] (6)

p̅=[σ₁²,σ₂², . . . ,σ_{K}²]^{T} (7)

where B̅ is a newly defined steering vector matrix composed of an angle θₖ, p̅ is a newly defined matrix composed of the power of K signals, σₖ² represents the power of a k th signal, (⋅)^{T} represents transposition, and b(θₖ) represents a steering vector corresponding to the angle θₖ, a value of which is shown in the following formula

b(θₖ)=[1,e^{-j(τ}^{_{k,2}}^{-τ}^{_{k,1}}⁾, . . . ,e^{-j(τ}^{_{k,M}}^{-τ}^{_{k,1}}⁾,e^{-j(τ}^{_{k,3}}^{-τ}^{_{k,2}}⁾, . . . ,e^{-j(τ}^{_{k,M}}^{-τ}^{_{k,2}}⁾, . . . ,e^{-j(τ}^{_{k,M}}^{-τ}^{_{k,M-1}}⁾]^{T} (8)

where τ_{k,m} represents a delay of the kth signal in a mth array element relative to a reference array element;

S2.2: setting a space grid spacing Δ and constructing an overcomplete angle set Θ={−90°, −90°+Δ, . . . , 90° −Δ}, so as to extend the formula (1) to Θ to obtain an overcomplete output model of the following formula

$$\begin{matrix}x = \vert Bp \vert & ( 9 ) \\ B = [ b ( - 90 ° ) , b ( - 90 ° + Δ ) , … , b ( 90 ° - Δ ) ] & ( 10 ) \\ p = \{ \begin{matrix}{\overline{p}}_{k} , & θ = {θ}_{k} \\ 0 , & else\end{matrix} & ( 11 )\end{matrix}$$

where B is a steering vector matrix formed by corresponding extension of B̅ to Θ, and p is a matrix formed by corresponding extension of p̅ to Θ;

S2.3: if there is a deviation angle δ when an actual information source direction \tilde{θ} fails to fall strictly on the constructed grid, the first-order Taylor expansion is used to modify the steering vector B(θ) to

B(\tilde{θ})=B(θ)+B′(θ)·δ (12)

where B(\tilde{θ}) is the modified steering vector;

S2.4: transforming the modified over-complete output model obtained in S2.3 into a nonconvex optimization problem of the following formula by an optimization theory

min_{p,δ}∥x−|Bp+B′δp|∥₂²∘ (13).

Furthermore, S3 is implemented by the following substeps:

S3.1: initializing a deviation angle matrix δ=0ₗ, optimizing the problem of formula (13), and transforming the problem into the following formula

min_{p,w}∥w∥₂²+γ₁∥p∥_{2,1}

s.t. p^{H}A_{q}p+w_{q}=x_{q}² (14)

wherein w=[w₁, w₂, . . . , w_{M}]^{T}, γ₁ represents a regularization constant, and, A_{q}=b_{q}^{H}b_{q}, b_{q} represents a qth line of B;

S3.2: transforming formula (14) into a convex optimization problem of the following formula by using the idea of a feasible point pursuit algorithm, and solving formula (15) to obtain a sparse matrix p, and then obtaining the corresponding angle of a non-zero item in the sparse matrix p;

min_{p,w,c}∥w∥₂²+γ∥p∥_{2,1}+μ₁∥c∥₁

s.t. p^{H}A_{q}p+w_{q}≤x_{q}²

2Re{z^{H}A_{q}p}+w_{q}+c_{q}≥x_{q}²+z^{H}A_{q}z

p≥0

c_{q}≥0 (15)

where c=μ[c₁, c₂, . . . , c_{Q}]^{T}, μ₁ represents another regularization constant, and z represents an arbitrary matrix with the same specification with p;

S3.3: solving the problem of formula (13) according to the sparse matrix p obtained in S3.2, and transforming the problem into the following problem

$${min}_{δ , w} {‖ w ‖}_{2}^{2} + {γ}_{2} {‖ δ ‖}_{2 , 1} \\ s . t . {C}^{2} + 2 CD δ + {δ}^{H} {E}_{q} δ + {w}_{q} = {x}_{q}^{2} \\ - \frac{Δ}{2} \leq δ \leq \frac{Δ}{2} \qquad ( 16 )$$

where γ₂ represents a regularization constant, C=Bp represents a known quantity, Dδ=B′δp, D represents an intermediate conversion quantity, δ represents a deviation angle matrix, and E_{q}=d_{q}^{H}d_{q}, d_{q} represents a qth line of D;

S3.4: transforming the formula (16) into a convex optimization problem of the following formula by using the idea of a feasible point pursuit algorithm, and obtaining a deviation angle estimation matrix δ by solving the formula (17)

$${min}_{δ , w , c} {‖ w ‖}_{2}^{2} + {γ}_{2} {‖ δ ‖}_{2 , 1} + {μ}_{2} {‖ c ‖}_{1} \\ s . t . {C}^{2} + 2 CD δ + {δ}^{H} {E}_{q} δ + {w}_{q} \leq {x}_{q}^{2} \\ {C}^{2} + 2 CD δ + {c}_{q} + 2 Re \{ {z}^{H} {E}_{q} δ \} + {w}_{q} \geq {x}_{q}^{2} + {z}^{H} {E}_{q} z \\ - \frac{Δ}{2} \leq 6 \leq \frac{Δ}{2} \\ {c}_{q} \geq 0 \qquad ( 17 )$$

S3.5: obtaining an index matrix β corresponding to the grid angle matrix θ obtained in S3.2, and dot-multiplying a sum result of the grid angle matrix θ and the deviation angle matrix δ obtained in S3.4 with the index matrix β to obtain a final estimated source angle as follows

\tilde{θ}=(θ+δ)·β (18)

where the index matrix β has a same dimension as the grid angle matrix θ, and the value of β at the index of the estimated angle is 1, with the rest being 0, (⋅) represents the dot multiplication of the matrix, that is, the multiplication of the corresponding elements of the matrix.

The present disclosure has the following beneficial effects:

The method for direction-of-arrival estimation based on sparse reconstruction in the presence of gain-phase error calibration of the present disclosure effectively eliminates the influence of the phase error in direction-of-arrival estimation by directly taking the magnitude of each element of the compensation covariance matrix; by adopting the sparse reconstruction technology, the present disclosure focuses on the deviation error caused when the compensation signal fails to fall strictly on the divided grid, thus improving the accuracy of direction-of-arrival estimation.

### BRIEF DESCRIPTION OF DRAWINGS

FIG. 1 is a flow chart of a method for DOA estimation based on sparse reconstruction in the presence of a gain-phase error.

FIG. 2 is a schematic diagram of grid division of an array spatial domain.

FIG. 3 is a comparison diagram of the relationship between the root mean square error and phase error in DOA estimation of the present disclosure and other algorithms in the same field.

FIG. 4 is a comparison chart of the relationship between the root mean square error and the signal-to-noise ratio in the DOA estimation of the present disclosure and other algorithms in the same field.

### DESCRIPTION OF EMBODIMENTS

The purpose and effect of the present disclosure will become clearer from the following detailed description of the present disclosure according to the drawings and preferred embodiments. It should be understood that the specific embodiments described here are only used to explain, rather than to limit the present disclosure.

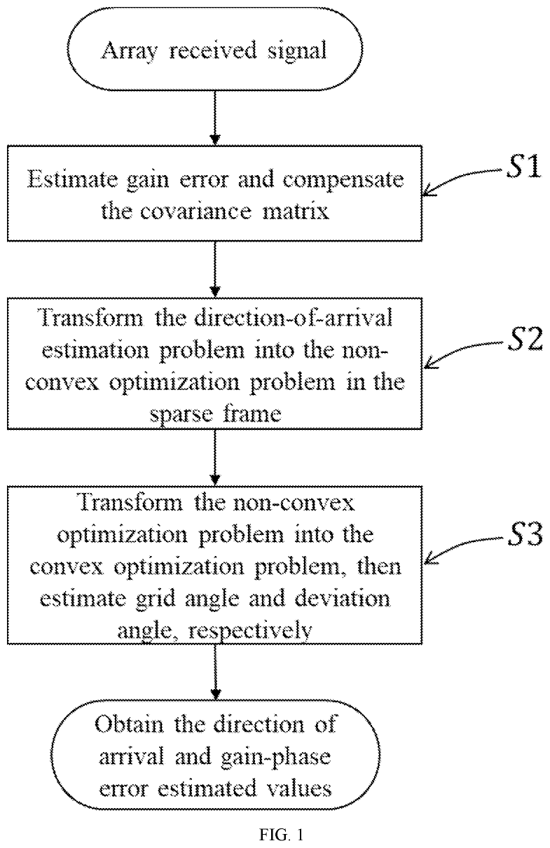

As shown in FIG. 1, the method for DOA estimation based on sparse reconstruction in the presence of a gain-phase error of the present disclosure includes the following steps:

S1, a covariance matrix is calculated from an array received signal, a noise power is estimated by adopting a characteristic decomposition method, and an gain error is estimated and compensated according to the noise power and main diagonal data of the covariance matrix to obtain a compensated covariance matrix; S1 is implemented by the following sub steps:

S1.1: calculating the covariance matrix R of the array received signal X(t), and then implementing eigenvalue decomposition on the covariance matrix R by using the following formula to obtain an eigenvalue λₘ in a descending order

R=Σₘ₌₁^{M}λₘvₘvₘ^{H} (1)

where M represents a number of array elements, λₘ represents the eigenvalue arranged in a descending order, vₘ represents an eigenvector corresponding to the eigenvalue λₘ and (⋅)^{H} represents the conjugate transpose;

S1.2: estimating the noise power \hat{σ}ₙ² by using the following formula according to the eigenvalue λₘ obtained in S1.1,

$${\hat{σ}}_{n}^{2} = \frac{1}{M - K} {\sum }_{m = K + 1}^{M} {λ}_{m} \qquad ( 2 )$$

where K represents a number of information sources;

S1.3: estimating the gain error by using the following formula according to the obtained covariance matrix R and the estimated value \hat{σ}ₙ² of the noise power

$${ρ}_{m} = \sqrt{\frac{{r}_{m , m} - {\hat{σ}}_{n}^{2}}{{r}_{1 , 1} - {\hat{σ}}_{n}^{2}}} \qquad ( 3 )$$

where ρₘ represents the estimated value of the gain error of the mth array element and r_{m,m} represents the value at the covariance matrix (m, m);

S1.4: compensating the estimated gain error matrix ρₘ in the covariance matrix R by using the following formula, and eliminating the influence of the gain error to obtain a compensated covariance matrix R₁

R₁=G⁻¹(R−\hat{σ}ₙ²I_{M})(G⁻¹)^{H} (4)

where G=diag{[ρ₁, ρ₂, . . . , ρ_{M}]} represents an gain error estimation matrix and I_{M} represents an identity matrix with a size of M.

S2, according to the compensated covariance matrix obtained in S1, a direction-of-arrival estimation problem is transformed into a nonconvex optimization problem in a sparse frame by a method of sparse reconstruction; S2 is specifically realized through the following substeps:

S2.1: according to the compensated covariance matrix R₁, taking the magnitude of elements in the matrix to obtain |R₁|, and taking the elements in an upper triangle area thereof, and eliminating the repeated elements of a same size in a main diagonal line, and then rearranging according to the following formula

x=[|r̅_{1,1}|,|r̅_{1,2}|, . . . ,|r̅_{1,M}|,|r̅_{2,3}|, . . . ,|r̅_{2,M}|, . . . ,|r̅_{M-1,M}|]^{T}=|B̅p̅| (5)

B̅=[b(θ₁),b(θ₂), . . . ,b(θ_{K})] (6)

p̅=[σ₁²,σ₂², . . . ,σ_{K}²]^{T} (7)

where B̅ is a newly defined steering vector matrix composed of an angle θₖ, p̅ is a newly defined matrix composed of the power of K signals, σₖ² represents the power of a k th signal, (⋅)^{T} represents transposition, and b(θₖ) represents a steering vector corresponding to the angle θₖ, a value of which is shown in the following formula

b(θₖ)=[1,e^{-j(τ}^{_{k,2}}^{-τ}^{_{k,1}}⁾, . . . ,e^{-j(τ}^{_{k,M}}^{-τ}^{_{k,1}}⁾,e^{-j(τ}^{_{k,3}}^{-τ}^{_{k,2}}⁾, . . . ,e^{-j(τ}^{_{k,M}}^{-τ}^{_{k,2}}⁾, . . . ,e^{-j(τ}^{_{k,M}}^{-τ}^{_{k,M-1}}⁾]^{T} (8)

where τ_{k,m} represents a delay of the kth signal in a mth array element relative to a reference array element;

S2.2: setting a space grid spacing Δ and constructing an overcomplete angle set Θ={−90°, −90°+Δ, . . . , 90° −Δ}, so as to extend the formula (1) to Θ to obtain an overcomplete output model of the following formula

$$\begin{matrix}x = \vert Bp \vert & ( 9 ) \\ B = [ b ( - 90 ° ) , b ( - 90 ° + Δ ) , … , b ( 90 ° - Δ ) ] & ( 10 ) \\ p = \{ \begin{matrix}{\overline{p}}_{k} , & θ = {θ}_{k} \\ 0 , & else\end{matrix} & ( 11 )\end{matrix}$$

where B is a steering vector matrix formed by corresponding extension of B̅ to Θ, and p is a matrix formed by corresponding extension of p̅, to Θ;

S2.3: if there is a deviation angle δ when an actual information source direction \tilde{θ} fails to fall strictly on the constructed grid, the first-order Taylor expansion is used to modify the steering vector B(θ) to

B(\tilde{θ})=B(θ)+B′(θ)·δ (12)

where B(\tilde{θ}) is the modified steering vector;

S2.4: transforming the modified over-complete output model obtained in S2.3 into a nonconvex optimization problem of the following formula by an optimization theory

min_{p,δ}∥x−|Bp+B′δp|∥₂²∘ (13).

S3, a two-parameter non-convex optimization problem is transformed into a convex optimization problem by using an alternating optimization method, and obtaining a grid angle and a deviation angle by solving the convex optimization problem, and obtaining a final information source angle estimation value; S3 is implemented by the following substeps:

S3.1: initializing a deviation angle matrix δ=0ₗ, optimizing the problem of formula (13), and transforming the problem into the following formula

min_{p,w}∥w∥₂²+γ₁∥p∥_{2,1}

s.t. p^{H}A_{q}p+w_{q}=x_{q}² (14)

wherein w=[w₁, w₂, . . . w_{M}]^{T}, γ₁ represents a regularization constant, and, A_{q}=b_{q}^{H}b_{q}, b_{q} represents a qth line of B;

S3.2: transforming formula (14) into a convex optimization problem of the following formula by using the idea of a feasible point pursuit algorithm, and solving formula (15) to obtain a sparse matrix p, and then obtaining the corresponding angle of a non-zero item in the sparse matrix p;

min_{p,w,c}∥w∥₂²+γ∥p∥_{2,1}+μ₁∥c∥₁

s.t. p^{H}A_{q}p+w_{q}≤x_{q}²

2Re{z^{H}A_{q}p}+w_{q}+c_{q}≥x_{q}²+z^{H}A_{q}z

p≥0

c_{q}≥0 (15)

where c=[c₁, c₂, . . . , c_{Q}]^{T}, μ₁ represents another regularization constant, and z represents an arbitrary matrix with the same specification with p;

S3.3: solving the problem of formula (13) according to the sparse matrix p obtained in S3.2, and transforming the problem into the following problem

$${min}_{δ , w} {‖ w ‖}_{2}^{2} + {γ}_{2} {‖ δ ‖}_{2 , 1} \\ s . t . {C}^{2} + 2 CD δ + {δ}^{H} {E}_{q} δ + {w}_{q} = {x}_{q}^{2} \\ - \frac{Δ}{2} \leq δ \leq \frac{Δ}{2} \qquad ( 16 )$$

where γ₂ represents a regularization constant, C=Bp represents a known quantity, Dδ=B′δp, D represents an intermediate conversion quantity, δ represents a deviation angle matrix, and E_{q}=d_{g}^{H}d_{q}, d_{q} represents a qth line of D;

S3.4: transforming the formula (16) into a convex optimization problem of the following formula by using the idea of a feasible point pursuit algorithm, and obtaining a deviation angle estimation matrix δ by solving the formula (17)

$${min}_{δ , w , c} {‖ w ‖}_{2}^{2} + {γ}_{2} {‖ δ ‖}_{2 , 1} + {μ}_{2} {‖ c ‖}_{1} \\ s . t . {C}^{2} + 2 CD δ + {δ}^{H} {E}_{q} δ + {w}_{q} \leq {x}_{q}^{2} \\ {C}^{2} + 2 CD δ + {c}_{q} + 2 Re \{ {z}^{H} {E}_{q} δ \} + {w}_{q} \geq {x}_{q}^{2} + {z}^{H} {E}_{q} z \\ - \frac{Δ}{2} \leq 6 \leq \frac{Δ}{2} \\ {c}_{q} \geq 0 \qquad ( 17 )$$

S3.5: obtaining an index matrix β corresponding to the grid angle matrix θ obtained in S3.2, and dot-multiplying a sum result of the grid angle matrix θ and the deviation angle matrix δ obtained in S3.4 with the index matrix β to obtain a final estimated source angle as follows

\tilde{θ}=(θ+δ)·β (18)

where the index matrix β has a same dimension as the grid angle matrix θ, and the value of β at the index of the estimated angle is 1, with the rest being 0, (⋅) represents the dot multiplication of the matrix, that is, the multiplication of the corresponding elements of the matrix.

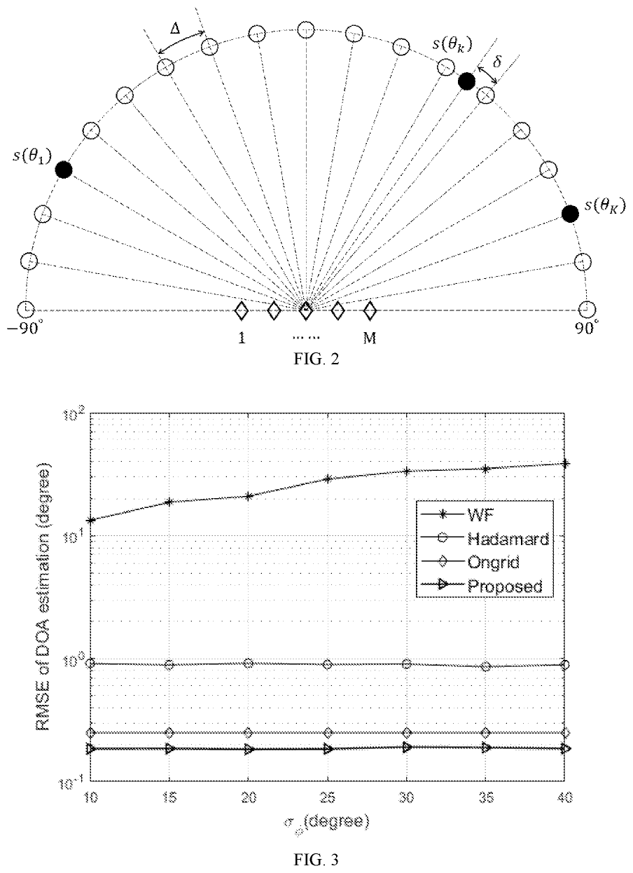

FIG. 2 is a schematic diagram of grid division of an array spatial domain, in which diamonds represent array elements, open circles represent grid points dividing the spatial domain, with a grid spacing being Δ, and filled circles represent actual directions of signals. When the hollow circle coincides with the solid circle, it means that the actual direction of the signal just falls on the grid, otherwise, the grid division model will produce a certain deviation error δ.

FIG. 3 is a comparison diagram of the relationship between the root mean square error and phase error in DOA estimation of the present disclosure and other algorithms in the same field. It can be seen from FIG. 3 that with the increase of an initial phase error, the root mean square error in DOA estimation of the present disclosure does not change, and this method (the proposed curve in the figure) can effectively eliminate the influence of a phase error in DOA estimation.

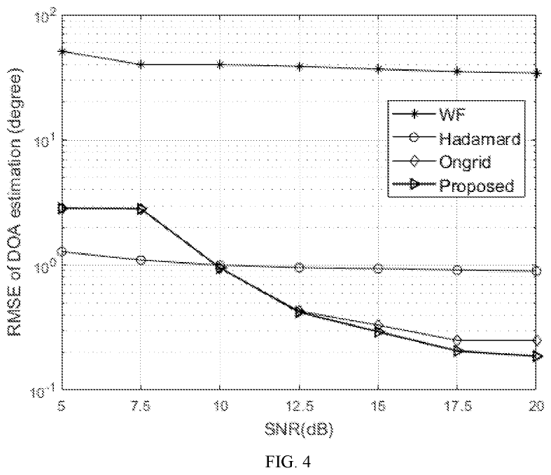

FIG. 4 is a comparison chart of the relationship between the root mean square error and the signal-to-noise ratio in DOA estimation between the present disclosure and other algorithms in the same field. It can be seen from FIG. 4 that the root mean square error of DOA estimation decreases with the increase of the signal-to-noise ratio, especially when the signal-to-noise ratio is greater than 15 dB, and the root mean square error of this method (the proposed curve in the figure) is smaller as compared with other algorithms, which shows that this method can improve the accuracy of DOA estimation.

It can be understood by those skilled in the art that the above description is only the preferred examples of the present disclosure, and is not intended to limit the present disclosure. Although the present disclosure has been described in detail with reference to the foregoing examples, those skilled in the art can still modify the technical solutions described in the foregoing examples or replace some of their technical features equivalently. Within the spirit and principle of the present disclosure, the modifications, equivalent replacements and so on shall be included within the scope of protection of the present disclosure.

What is claimed is:

1. A method for direction-of-arrival estimation based on sparse reconstruction in the presence of gain-phase error, comprising the following steps:
S1, calculating a covariance matrix R from an array received signal X(t), estimating a noise power by adopting a characteristic decomposition method, and estimating and compensating an gain error according to the noise power and main diagonal data of the covariance matrix to obtain a compensated covariance matrix R₁;
S2, according to the compensated covariance matrix R₁ obtained in S1, transforming a direction-of-arrival estimation problem into a nonconvex optimization problem in a sparse frame by a method of sparse reconstruction, which is specifically realized through the following substeps:
S2.1: according to the compensated covariance matrix R₁, taking the magnitude of elements in the matrix to obtain |R₁|, and taking the elements in an upper triangle area thereof, and eliminating the repeated elements of a same size in a main diagonal line, and then rearranging according to the following formula:
x=[|r̅_{1,1}|,|r̅_{1,2}|, . . . ,|r̅_{1,M}|,|r̅_{2,3}|, . . . ,|r̅_{2,M}|, . . . ,|r̅_{M-1,M}|]^{T}=|B̅p̅| (1)
B̅=[b(θ₁),b(θ₂), . . . ,b(θ_{K})] (2)
p̅=[σ₁²,σ₂², . . . ,σ_{K}²]^{T} (3)
where B̅ is a newly defined steering vector matrix composed of an angle θₖ, p̅ is a newly defined matrix composed of the power of K signals, σₖ² represents the power of a k^{th} signal, (⋅)^{T} represents transposition, and b(θₖ) represents a steering vector corresponding to the angle θₖ, a value of which is shown in the following formula
b(θₖ)=[1,e^{-j(τ}^{_{k,2}}^{-τ}^{_{k,1}}⁾, . . . ,e^{-j(τ}^{_{k,M}}^{-τ}^{_{k,1}}⁾,e^{-j(τ}^{_{k,3}}^{-τ}^{_{k,2}}⁾, . . . ,e^{-j(τ}^{_{k,M}}^{-τ}^{_{k,2}}⁾, . . . ,e^{-j(τ}^{_{k,M}}^{-τ}^{_{k,M-1}}⁾]^{T} (4)
where τ_{k,m} represents a delay of the k^{th} signal in an m^{th} array element relative to a reference array element;
S2.2: setting a space grid spacing Δ and constructing an overcomplete angle set Θ={−90°, −90°+Δ, . . . , 90° −Δ}, so as to extend the formula (1) to Θ to obtain an overcomplete output model of the following formula:
$$\begin{matrix}x = \vert Bp \vert & ( 5 ) \\ B = [ b ( - 90 ° ) , b ( - 90 ° + Δ ) , … , b ( 90 ° - Δ ) ] & ( 6 ) \\ p = \{ \begin{matrix}{\overline{p}}_{k} , & θ = {θ}_{k} \\ 0 , & else\end{matrix} & ( 7 )\end{matrix}$$
where B is a steering vector matrix formed by corresponding extension of B̅ to Θ, and p is a matrix formed by corresponding extension of p̅ to Θ;
S2.3: if there is a deviation angle δ when an actual information source direction \tilde{θ} fails to fall strictly on the constructed grid, the first-order Taylor expansion is used to modify the steering vector B(θ) to
B(\tilde{θ})=B(θ)+B′(θ)·δ (8)
where B(\tilde{ƒ}) is the modified steering vector;
S2.4: transforming the modified over-complete output model obtained in S2.3 into a nonconvex optimization problem of the following formula by an optimization theory
min_{p,δ}∥x−|Bp+B′δp|∥₂²∘ (9)
S3, transforming a two-parameter non-convex optimization problem into a convex optimization problem by using an alternating optimization method, and obtaining a grid angle and a deviation angle by solving the convex optimization problem, and obtaining a final information source angle estimation value.

2. The method for direction-of-arrival estimation based on sparse reconstruction in the presence of gain-phase error according to claim 1, wherein S1 is implemented by the following sub step s:
S1.1: calculating the covariance matrix R of the array received signal X(t), and then implementing eigenvalue decomposition on the covariance matrix R by using the following formula to obtain an eigenvalue λₘ in a descending order:
R=Σₘ₌₁^{M}λₘvₘvₘ^{H} (10)
where M represents a number of array elements, λₘ represents the eigenvalue arranged in a descending order, vₘ represents an eigenvector corresponding to the eigenvalue λₘ and (⋅)^{H} represents the conjugate transpose;
S1.2: estimating the noise power \hat{σ}ₙ² by using the following formula according to the eigenvalue λₘ obtained in S1.1,
$${\hat{σ}}_{n}^{2} = \frac{1}{M - K} {\sum }_{m = K + 1}^{M} {λ}_{m} \qquad ( 11 )$$
where K represents a number of information sources;
S1.3: estimating the gain error by using the following formula according to the obtained covariance matrix R and the estimated value \hat{σ}ₙ² of the noise power:
$${ρ}_{m} = \sqrt{\frac{{r}_{m , m} - {\hat{σ}}_{n}^{2}}{{r}_{1 , 1} - {\hat{σ}}_{n}^{2}}} \qquad ( 12 )$$
where ρₘ represents the estimated value of the gain error of the m^{th} array element and r_{m,m} represents the value at the covariance matrix (m, m);
S1.4: compensating the estimated gain error matrix ρₘ in the covariance matrix R by using the following formula, and eliminating the influence of the gain error to obtain a compensated covariance matrix R₁:
R₁=G⁻¹(R−\hat{σ}ₙ²I_{M})(G⁻¹)^{H} (13)
where G=diag{[ρ₁,ρ₂, . . . , ρ_{M}]} represents an gain error estimation matrix and I_{M} represents an identity matrix with a size of M.

3. The method for direction-of-arrival estimation based on sparse reconstruction in the presence of gain-phase error according to claim 1, wherein S3 is implemented by the following substeps:
S3.1: initializing a deviation angle matrix δ=0ₗ, optimizing the problem of formula (13), and transforming the problem into the following formula:
min_{p,w}∥w∥₂²+γ₁∥p∥_{2,1}
s.t. p^{H}A_{q}p+w_{q}=x_{q}² (14)
wherein w=[w₁, w₂, . . . , w_{M}]^{T}, γ₁ represents a regularization constant, and, A_{q}=b_{q}^{H}b_{q}, b_{q} represents a q^{th} line of B;
S3.2: transforming formula (14) into a convex optimization problem of the following formula by using the idea of a feasible point pursuit algorithm, and solving formula (15) to obtain a sparse matrix p, and then obtaining the corresponding angle of a non-zero item in the sparse matrix p;
min_{p,w,c}∥w∥₂²+γ∥p∥_{2,1}+μ₁∥c∥₁
s.t. p^{H}A_{q}p+w_{q}≤x_{q}²
2Re{z^{H}A_{q}p}+w_{q}+c_{q}≥x_{q}²+z^{H}A_{q}z
p≥0
c_{q}≥0 (15)
where c=[c₁, c₂, . . . , c_{Q}]^{T}, μ₁ represents another regularization constant, and z represents an arbitrary matrix with the same specification with p;
S3.3: solving the problem of formula (13) according to the sparse matrix p obtained in S3.2, and transforming the problem into the following problem:
$${min}_{δ , w} {‖ w ‖}_{2}^{2} + {γ}_{2} {‖ δ ‖}_{2 , 1} \\ s . t . {C}^{2} + 2 CD δ + {δ}^{H} {E}_{q} δ + {w}_{q} = {x}_{q}^{2} \\ - \frac{Δ}{2} \leq δ \leq \frac{Δ}{2} \qquad ( 16 )$$
where γ₂ represents a regularization constant, C=Bp represents a known quantity, Dδ=B′δp, D represents an intermediate conversion quantity, δ represents a deviation angle matrix, and E_{q}=d_{q}^{H}d_{q}, d_{q} represents a q^{th} line of D;
S3.4: transforming the formula (16) into a convex optimization problem of the following formula by using the idea of a feasible point pursuit algorithm, and obtaining a deviation angle estimation matrix δ by solving the formula (17):
$${min}_{δ , w , c} {‖ w ‖}_{2}^{2} + {γ}_{2} {‖ δ ‖}_{2 , 1} + {μ}_{2} {‖ c ‖}_{1} \\ s . t . {C}^{2} + 2 CD δ + {δ}^{H} {E}_{q} δ + {w}_{q} \leq {x}_{q}^{2} \\ {C}^{2} + 2 CD δ + {c}_{q} + 2 Re \{ {z}^{H} {E}_{q} δ \} + {w}_{q} \geq {x}_{q}^{2} + {z}^{H} {E}_{q} z \\ - \frac{Δ}{2} \leq 6 \leq \frac{Δ}{2} \\ {c}_{q} \geq 0 \qquad ( 17 )$$
S3.5: obtaining an index matrix β corresponding to the grid angle matrix θ obtained in S3.2, and dot-multiplying a sum result of the grid angle matrix θ and the deviation angle matrix δ obtained in S3.4 with the index matrix β to obtain a final estimated source angle as follows:
\tilde{θ}=(θ+δ)·β (18)
where the index matrix β has a same dimension as the grid angle matrix θ, and the value of β at the index of the estimated angle is 1, with the rest being 0, (⋅) represents the dot multiplication of the matrix, that is, the multiplication of the corresponding elements of the matrix.
